(19) United States
(12) Patent Application Publication
(10) Pub. No.: US 2016/0358462 A1
(43) Pub. Date: Dec. 8, 2016

(54) METHOD AND SYSTEM FOR VEHICLE DATA INTEGRATION

(71) Applicant: Yeon Technologies Co., Ltd., Taipei City (TW)

(72) Inventors: Kuo Feng Kao, Taipei City (TW); Chih-Wei Hou, Taipei City (TW); Chih Ting Chueh, Taipei City (TW); Yung Shen Shen, Taipei City (TW)

(21) Appl. No.: 15/011,693

(22) Filed: Feb. 1, 2016

(30) Foreign Application Priority Data
Jun. 5, 2015 (TW) 104118370

(51) Int. Cl. G08G 1/017; G08G 1/01; G08G 1/04

(52) U.S. Cl. CPC G08G 1/017; G08G 1/04; G08G 1/0125

(57) ABSTRACT

The present invention relates to a method and system for vehicle data integration. The method is comprised of the steps of: capturing a plurality of vehicle data and sending the vehicle data to a data filter; configuring the data filter to determine the quality of the vehicle data; reading a plurality of contents of different properties of the vehicle data and sending the contents to a server; configuring the sever to determine if at least two contents of different properties exist within a predetermined time interval; matching the contents into at least one dataset and sending the dataset to a buffer; configuring the buffer to determine if any of the datasets in the buffer has occurred for over a predetermined number of times; and sending at least one dataset having occurred for over the predetermined number of times to a database.

### FIELD OF THE INVENTION

The present invention relates to a method and system for vehicle data integration, and more particularly to a method and system for integrating E-tag data with license plate data of vehicles.

### BACKGROUND OF THE INVENTION

Automatic number plate recognition (ANPR) system is a frequently used traffic surveillance facility. The system captures images of vehicles by utilizing closed circuit monitors, traffic enforcement cameras, or designated ANPR cameras installed on roadways; and reads license plate numbers of the vehicles by optical character recognition technologies. ANPR system has been mainly used for assisting police departments or related law enforcement authorities in obtaining traffic data, on-road vehicle data, and traveling records of vehicles on major roadways. However, recognition accuracy of the ANPR system has been known to be affected by environmental interferences.

Electronic toll collection (ETC) system is also a road management system that has gained increasing popularity over the years. The ETC system utilizes radio frequency identification (RFID) readers installed on roadways and electronic tag (or E-tag) properly displayed on vehicles to automatically identify and classify passing vehicles, and thus charge or fine the vehicles accordingly. The system has been most commonly used on highways; it has demonstrated to reduce labor costs, alleviate traffic jams, and offer drivers conveniences. The system has also provided a mean for recording traveling routes of passing vehicles in a larger scale. However, as the detection of radiofrequency signals may be interfered by the surrounding environments, sensitivity and accuracy have also been an issue of the ETC system.

Meanwhile, how to effectively improve the efficiency of spotting lost vehicles, stolen vehicles, suspicious vehicles and other questionable vehicles has been an unsolved societal issue common to most countries around the world. Additionally, using fake license plates or sharing E-tags to avoid obligations or fines have also been a serious long-term societal issue. Over the years, law enforcement authorities and vehicle/traffic management related businesses have been searching for a management method for integrating vehicle data of various types, with the aims of improving law enforcement efficiencies and reducing labor costs. However, there has not been a method capable of integrating large quantities of vehicle data collected by the two most common traffic management systems, ANPR and ETC.

### SUMMARY OF THE INVENTION

To offer a solution to the aforementioned problem, the present invention provides a method and system for integrating vehicle data, which utilizes common hardware systems for vehicle data collection to gather actual on-road vehicle data and employ a matching methodology to integrate the vehicle data. The present invention offers law enforcement authorities a more effective vehicles management measure and reduces the time for spotting suspicious vehicles, stolen vehicles, vehicles with fake license plates, and other questionable vehicles and therefore reduces crime and criminal behaviors. Furthermore, the data provided by the method and system of the present invention may be compared with internal data of relevant law enforcement authorities, so as to provide assistances in fast identification of questionable vehicles and updating vehicle information.

The method for vehicle data integration of the present invention comprises (a) capturing a plurality of vehicle data and sending the plurality of vehicle data to a data filter; (b) configuring the data filter to determine a quality of the plurality of vehicle data, if the quality is readable, going to Step (c), if the quality is unreadable, going to Step (h); (c) reading a plurality of contents of different properties of the plurality of vehicle data and sending the plurality of contents of different properties to a server; (d) configuring the sever to determine if at least two of the plurality of contents of different properties exist within a predetermined time interval, if yes, going to Step (e), if no, going to Step (h); (e) matching the plurality of contents of different properties into at least one dataset and sending the at least one dataset to a buffer; (f) configuring the buffer to determine if any the at least one dataset in the buffer has occurred for over a predetermined number of times, if yes, going to Step (g), if no, going to Step (a); (g) sending the at least one dataset having occurred for over the predetermined number of times to a database; and (h) end.

The system for vehicle data integration of the present invention comprises a data filter, configured to determine a quality of a plurality of vehicle data and reading a plurality of contents of different properties of the plurality of vehicle data; a server, coupled to the data filter, configured to determine if at least two of the plurality of contents of different properties exist within a predetermined time interval and matching the plurality of contents of different properties into at least one dataset; a buffer, coupled to the server, configured to determine if any one dataset in the buffer has occurred for over a predetermined number of times; and a database, coupled to the buffer, configured to store the plurality of contents of different properties and at least one dataset having occurred for over the predetermined number of times.

For making the above and other purposes, features and benefits become more readily apparent to those ordinarily skilled in the art, the preferred embodiments and the detailed descriptions with accompanying drawings will be put forward in the following descriptions.

### BRIEF DESCRIPTION OF THE DRAWINGS

The present invention will become more readily apparent to those ordinarily skilled in the art after reviewing the following detailed description and accompanying drawings, in which:

FIG. 1 is a sequence diagram of an embodiment of the vehicle data integration method of the present invention;

FIG. 2 is a module diagram of the embodiment of the vehicle data integration system of the present invention;

FIG. 3A is a schematic illustration of vehicle data matching of the embodiment of the vehicle data integration system of the present invention; and

FIG. 3B is another schematic illustration of vehicle data matching of the embodiment of the vehicle data integration system of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

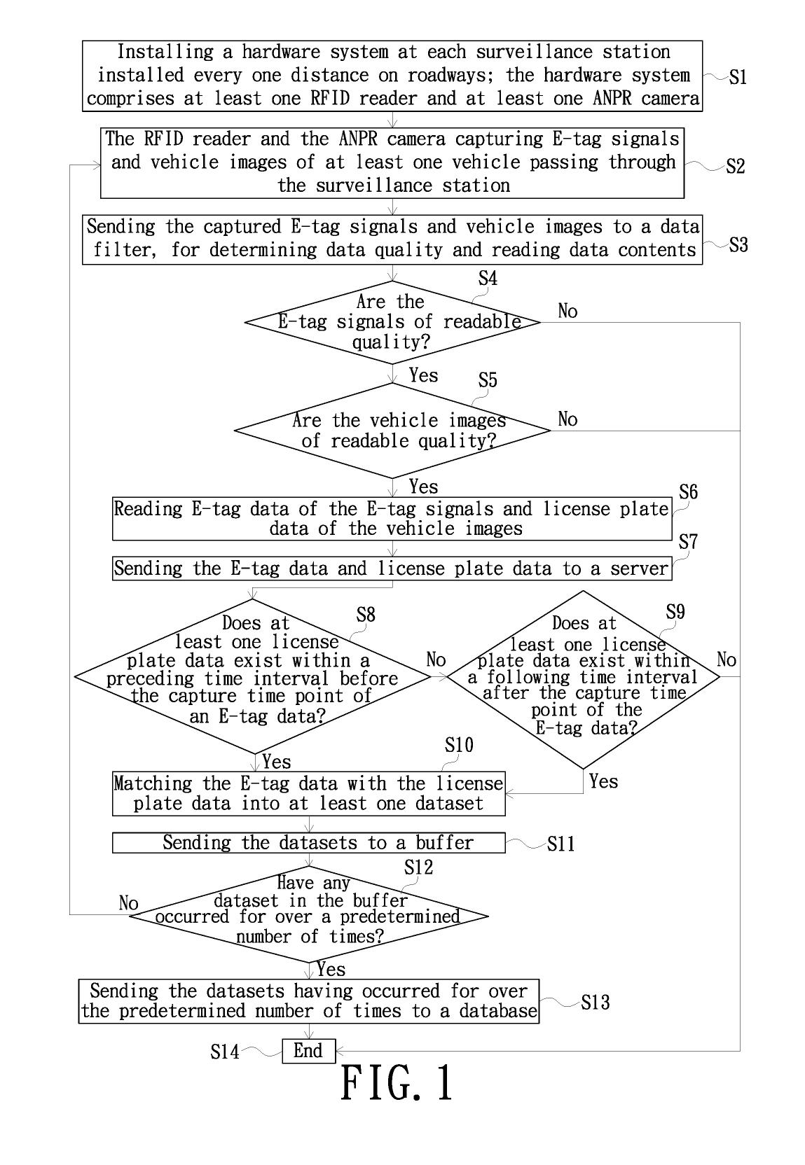

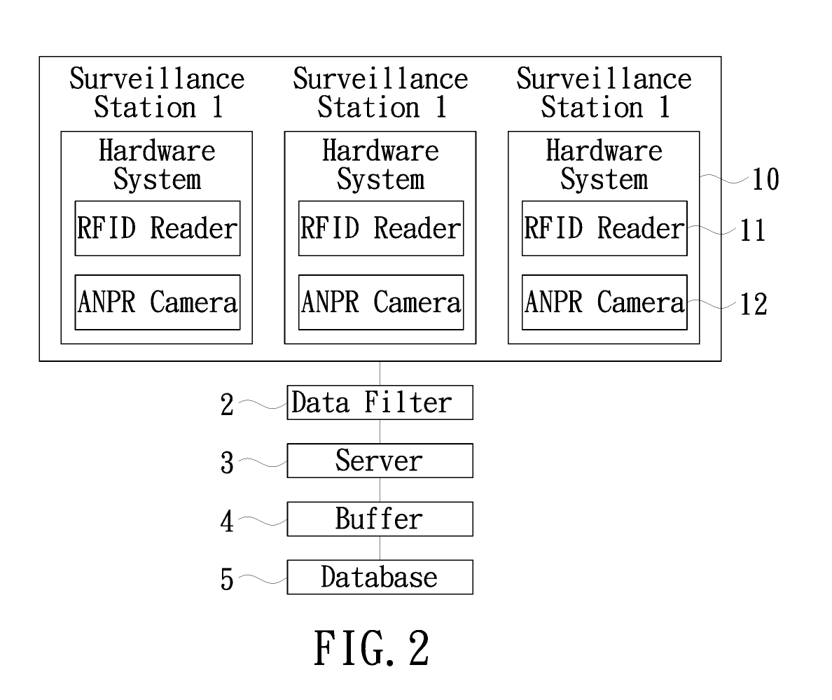

Referring to FIGS. 1 and 2, which respectively illustrate the sequence of an embodiment of the vehicle data integration method of the present invention and the system module of the embodiment of the vehicle data integration system of the present invention. As shown in FIG. 1, the method for vehicle date integration in this embodiment comprises the following steps.

Step S1—Installing a hardware system 10 at each surveillance station 1 installed every one distance on roadways. The hardware system 10 comprises at least one radio frequency identification (RFID) reader 11 and at least one automatic number plate recognition (ANPR) camera 12. In this embodiment, the numbers of RFID reader 11 and ANPR camera 12 to be installed may be adjusted according to conditions of traffic lanes, readable range of the RFID reader 11, or working range of the ANPR camera 12. Additionally, the distance between which surveillance stations 1 are installed may be adjusted according to specific needs; and RFID reader 11 and ANPR camera 12 are preferably installed in a way that every one traffic lane has one designated RFID reader 11 and one designated ANPR camera 12 aiming specifically at that traffic lane. In other words, surveillance station 1 may be, but not limited to, installed with a plurality of RFID readers 11 and a plurality of ANPR cameras 12 in another embodiment.

Step S2—The RFID reader 11 and the ANPR camera 12 capturing electronic tag (E-tag) signals and vehicle images of at least one vehicle passing through the surveillance station 1. In this embodiment, RFID reader 11 is used to capture at least one E-tag signal of the passing vehicles, while ANPR camera 12 is adopted to capture at least one vehicle image of the passing vehicles.

Step S3—Sending the captured E-tag signals and vehicle images to a data filter 2, for determining data quality and reading data contents. Delivery of the vehicle data to the data filter 2 may be real-time or at a predetermined time point. For example, the vehicle data may be sent out upon completion of data capturing; that is, E-tag signals and vehicle images are sent immediately to the data filter 2 once they are captured by the hardware system 10. In another embodiment, a fixed time point for delivery of vehicle data may be set, at 2 a.m. for example; that is, all E-tag signals and vehicle images captured by the hardware system 10 within a single day are sent to the data filter 2 at once at 2 a.m.

Step S4—The data filter 2 determining the quality of at least one E-tag signal. If the E-tag signal is of readable quality, going to Step S5; whereas if the E-tag signal is unreadable, going to Step S14.

Step S5—Determining the quality of at least one vehicle image. If the vehicle image is of readable quality, going to Step S6; whereas if the vehicle image is unreadable, going to Step S14. It is to be understood that the order of Step S4 and Step S5 is reversible; that is, the sequence of determination of the quality of E-tag signals and vehicle images is adjustable according to specific needs during actual implementation.

Step S6—Reading at least one E-tag data of the at least one E-tag signal and at least one license plate data of the at least one vehicle image. It is to be understood that the contents read out from the E-tag signals and vehicle images are not limited to E-tag data and license plate data; the contents may also include time of capture, number of reads, traveling route of vehicle, registered driver information, color of vehicle, and make and model of vehicle. Traveling routes of vehicles may be further adopted in analyzing vehicles or the route choice habits of drivers.

Step S7—Sending the at least one E-tag data and the at least one license plate data to a server 3. Meanwhile, the delivery may also include sending at least one vehicle image to a database 5.

Step S8—The server 3 determining if at least one license plate data exists within a predetermined preceding time interval before the capture time point of each of the E-tag data. If at least one license plate data does exist, going to Step S10; whereas if no license plate data is present, going to Step S9. The preferred value of the predetermined preceding time interval is, but not limited to, 3 seconds; and is adjustable according to actual needs.

Step S9—Determining if at least one license plate data exists within a predetermined following time interval after the capture time point of the E-tag data. If at least one license plate data does exist, going to Step S10; whereas if no license plate data is present, going to Step S14. The preferred value of the predetermined following time interval is, but not limited to, 3 seconds; and is adjustable according to actual needs.

It is to be understood that the order of Step S8 and Step S9 is reversible; that is, the sequence of the time intervals to be determined is adjustable according to specific needs during actual implementation. Additionally, the determination of data existence may center around the capture time point of license plate data instead; that is, the server 3 may also be configured to determine if at least one E-tag data exists within 3 seconds before and/or after the capture time point of each license plate data. Furthermore, one may optionally perform either Step S8 or Step S9, or may combine the two steps into one; that is, determining data existence at a time span of 6 seconds, covering 3 seconds before and 3 seconds after a certain time point, at once.

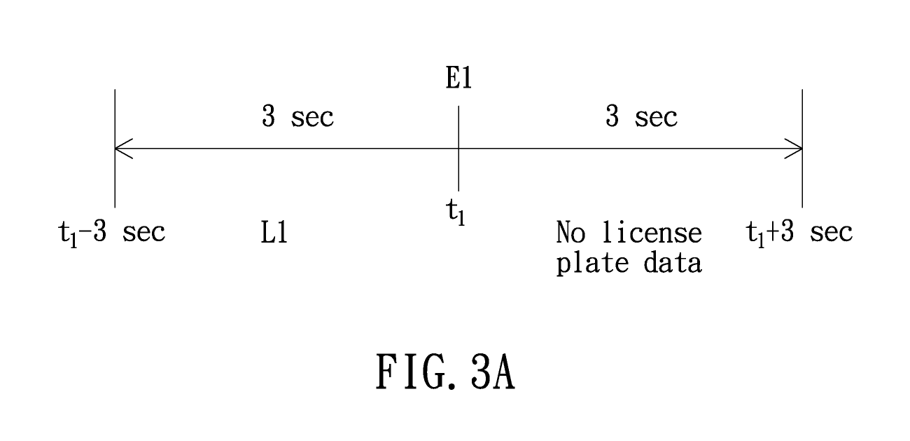

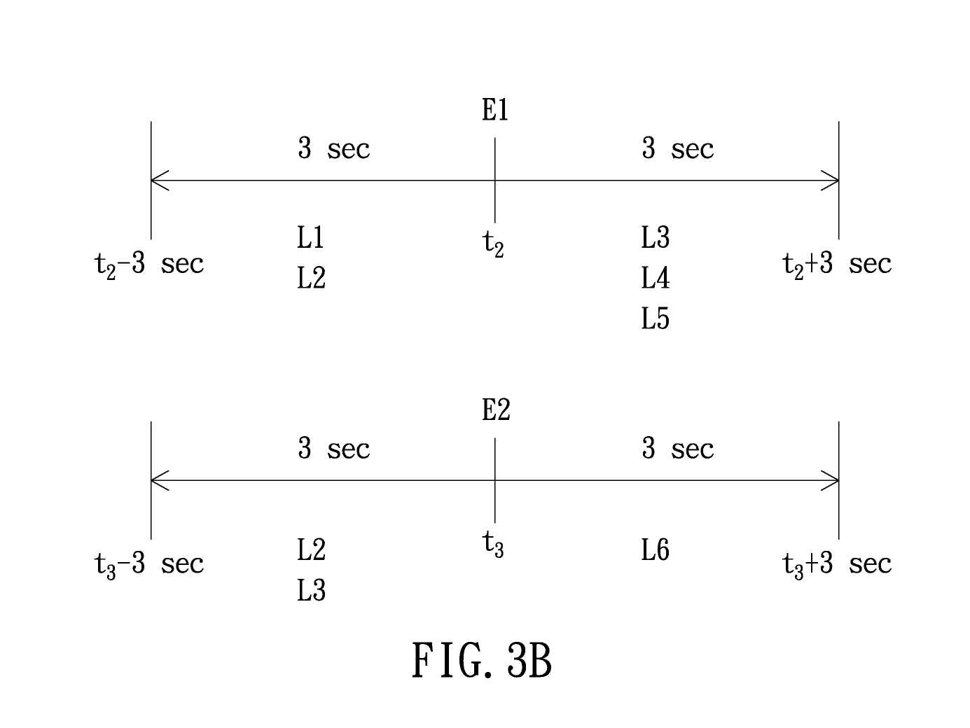

Step S10—Matching the E-tag data with the license plate data into at least one dataset. In this embodiment, a dataset includes an E-tag data and a license plate data. For example, referring to FIGS. 3A and 3B, which illustrate vehicle data matching methodology of this embodiment of the method and system for vehicle data integration of the present invention. As shown in FIG. 3A, E1 represents an E-tag data captured by a RFID reader 11 at a time point t₁, and the server 3 determines that a license plate data L1 exists within 3 seconds before the time point t₁ and that no license plate data exists within 3 seconds after the time point t₁. Therefore, a dataset (E1,L1) is formed by matching the E-tag data E1 with the license plate data L1. Similarly, as shown in FIG. 3B, E1 and E2 represent two E-tag data captured at time points t₁ and t₂, respectively; server 3 determines that when E-tag data E1 was captured at t₂ two license plate data, L1 and L2, exist within 3 seconds before t₂, and that three license plate data, L3, L4 and L5, exist within 3 seconds after t₂. Meanwhile, server 3 also determines that when E-tag data E2 was captured at t₃ two license plate data L2 and L3 exist within 3 seconds before t₃, and that one license plate data L6 exists within 3 seconds after t₃. Consequently, eight datasets, namely (E1,L1), (E1,L2), (E1,L3), (E1,L4), (E1,L5), (E2,L2), (E2,L3) and (E2,L6), are formed by matching E-tag data E1 and E2 with the respective license plate data L1-L6. It is to be noted that E-tag data E1 and E2 may be captured at the same or different surveillance stations 1; however, matching E-tag data and license plate data must be captured at the same surveillance station 1, and the same datasets may be formed from vehicle data captured at different time points. For example, E-tag data E1 and license plate data L1 in FIG. 3A may be captured at surveillance station A on a Monday, E-tag data E1 and license plate data L1-L5 in FIG. 3B may be captured at surveillance station B on a Tuesday, and E-tag data E2 and license plate data L2, L3, and L6 may be captured at surveillance station B on a Wednesday. In this example, the same dataset (E1,L1) are matched from two sets of vehicle data captured at surveillance station A on a Monday and at surveillance station B on a Tuesday, respectively.

Step S11—Sending the at least one dataset to a buffer 4.

Step S12—The buffer 4 determining if any one dataset in the buffer 4 has occurred for over a predetermined number of times. If yes, going to Step S13; if no, going to Step S2. The preferred value of the predetermined number is, but not limited to, 3; and over 3 includes 3 itself. Additionally, the larger the predetermined number, the higher accuracy the vehicle data integration is. For example, if buffer 4 only contains the datasets illustrated in FIGS. 3A and 3B, the buffer 4 would determine that dataset (E1,L1) has occurred for twice and that the other 7 datasets (E1,L2), (E1,L3), (E1,L4), (E1,L5), (E2,L2), (E2,L3), and (E2,L6) have each occurred for once.

Step S13—Sending at least one dataset having occurred for over the predetermined number of times to the database 5.

Step S14—End.

From the aforementioned steps, E-tag data of a vehicle associating with its corresponding license plate data is obtained. For example, if the predetermined number in Step S12 was 2, dataset (E1,L1) which has occurred for twice in the example illustrated in FIGS. 3A and 3B would be sent to the database 5, resulting in associating E-tag data E1 and license plate data L1 with a specific vehicle. Besides, in addition to system administrators, database 5 may also be given access to for law enforcement authorities to enhance law enforcement efficiencies.

Referring now to FIG. 2, which illustrates the system module of the embodiment of the vehicle data integration system of the present invention. As shown in FIG. 2, the vehicle data integration system comprises a plurality of surveillance stations 1, a data filter 2, a server 3, a buffer 4, and a database 5; and each of the plurality of surveillance stations 1 includes a hardware system 10.

Each of the hardware system 10 further includes at least one RFID reader 11 and at least one ANPR camera 12, for capturing a plurality of vehicle data. The RFID reader 11 is used to capture at least one E-tag signal of vehicles passing through the surveillance station 1, while the ANPR camera 12 is adopted to capture at least one vehicle image of the vehicles passing through the surveillance station 1.

The data filter 2 is coupled to a plurality of hardware system 10 and is used for determining data quality and reading data contents. It is to be understood that the contents read out from vehicle data are not limited to E-tag data and license plate data; the contents may also include time of capture, number of reads, traveling route of vehicle, registered driver information, color of vehicle, and make and model of vehicle. Traveling routes of vehicles may be further adopted in analyzing vehicles or the route choice habits of drivers.

The server 3 is coupled to the data filter 2 and is used for determining if at least two contents of different properties exist within a predetermined time interval and for matching the contents into at least one dataset. In this embodiment, a dataset includes an E-tag data and a license plate data. Please refer to FIGS. 3A and 3B and the aforementioned Step S10 to gain a deeper comprehension of the vehicle data matching methodology of this embodiment of the present invention.

The buffer 4 is coupled to the server 3 and is used for determining if any dataset in the buffer 4 has occurred for over a predetermined number of times. The larger the predetermined number, the higher accuracy the vehicle data integration is.

The database 5 is coupled to the buffer 4 and is used for storing the contents of different properties and datasets having occurred for over the predetermined number of times. In this embodiment, the contents of different properties stored in the database 5 include, but not limited to, vehicle images, E-tag data and vehicle data.

The method and system for vehicle data integration provided in the embodiment of the present invention utilize common hardware systems for vehicle data collection to gather actual on-road vehicle data and employ a matching methodology to integrate the vehicle data, so as to offer law enforcement authorities a more effective vehicles management measure. In addition, the present invention may also be utilized in spotting suspicious vehicles, stolen vehicles, vehicles with fake license plates, and other questionable vehicles. Moreover, the data provided by the method and system of the present invention may be compared with internal data of relevant law enforcement authorities, so as to provide assistances in fast identification of questionable vehicles and updating vehicle information.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for vehicle data integration, comprising the steps of:
a) capturing a plurality of vehicle data and sending the plurality of vehicle data to a data filter;
b) configuring the data filter to determine a quality of the plurality of vehicle data, if the quality is readable, going to Step c), if the quality is unreadable, going to Step h);
c) reading a plurality of contents of different properties of the plurality of vehicle data and sending the plurality of contents of different properties to a server;
d) configuring the sever to determine if at least two of the plurality of contents of different properties exist within a predetermined time interval, if yes, going to Step e), if no, going to Step h);
e) matching the plurality of contents of different properties into at least one dataset and sending the at least one dataset to a buffer;
f) configuring the buffer to determine if any the at least one dataset in the buffer has occurred for over a predetermined number of times, if yes, going to Step g), if no, going to Step a);
g) sending the at least one dataset having occurred for over the predetermined number of times to a database; and
h) end.

2. The method for vehicle data integration according to claim 1, wherein prior to Step a) further comprises the step of:
z) installing a hardware system at each of a plurality of surveillance stations installed every one distance on roadways.

3. The method for vehicle data integration according to claim 2, wherein the hardware system comprises at least one RFID reader and at least one ANPR camera.

4. The method for vehicle data integration according to claim 1, wherein Step a) further comprises the steps of:
a1) configuring at least one RFID reader and at least one ANPR camera to capture at least one E-tag signal and at least one vehicle image of all vehicles passing through a surveillance station; and
a2) sending the at least one E-tag signal and the at least one vehicle image to the data filter.

5. The method for vehicle data integration according to claim 1, wherein Step b) further comprises the steps of:
b1) configuring the data filter to determine if at least one E-tag signal is of readable quality, if yes, going to Step b2), if no, going to Step h); and
b2) determining if at least one vehicle image is of readable quality, if yes, going to Step c), if no, going to Step h).

6. The method for vehicle data integration according to claim 1, wherein Step b) further comprises the steps of:
b1′) configuring the data filter to determine if at least one vehicle image is of readable quality, if yes, going to Step b2′), if no, going to Step h); and
b2′) determining if at least one E-tag signal is of readable quality, if yes, going to Step c), if no, going to Step h).

7. The method for vehicle data integration according to claim 1, wherein Step c) further comprises the steps of:
c1) reading at least one E-tag data of at least one E-tag signal and at least one license plate data of at least one vehicle image; and
c2) sending the least one E-tag data and the at least one license plate data to the server.

8. The method for vehicle data integration according to claim 1, wherein Step d) further comprises the steps of:
d1) configuring the server to determine if at least one license plate data exists within a predetermined preceding time interval before a capture time point of each of at least one E-tag data, if yes, going to Step e), if no, going to Step d2); and
d2) determining if at least one license plate data exists within a predetermined following time interval after the capture time point of the at least one E-tag data, if yes, going to Step e), if no, going to Step h).

9. The method for vehicle data integration according to claim 1, wherein Step d) further comprises the steps of:
d1′) configuring the server to determine if at least one license plate data exists within a predetermined following time interval after a capture time point of each of at least one E-tag data, if yes, going to Step e), if no, going to Step d2′); and
d2′) determining if at least one license plate data exists within a predetermined preceding time interval before the capture time point of the at least one E-tag data, if yes, going to Step e), if no, going to Step h).

10. The method for vehicle data integration according to claim 1, wherein Step e) further comprises the steps of:
e1) matching at least one E-tag data with at least one license plate data into at least one dataset; and
e2) sending the at least one dataset to the buffer.

11. A system for vehicle data integration, comprising:
a data filter, configured to determine a quality of a plurality of vehicle data and read a plurality of contents of different properties of the plurality of vehicle data;
a server, coupled to the data filter, configured to determine if at least two of the plurality of contents of different properties exist within a predetermined time interval and match the plurality of contents of different properties into at least one dataset;
a buffer, coupled to the server, configured to determine if any the at least one dataset in the buffer has occurred for over a predetermined number of times; and
a database, coupled to the buffer, configured to store the plurality of contents of different properties and the at least one dataset having occurred for over the predetermined number of times.

12. The system for vehicle data integration according to claim 11, further comprising:
a plurality of hardware systems, wherein each of the plurality of hardware system is installed at each of a plurality of surveillance stations installed every one distance on traffic roads, and the plurality of hardware systems are coupled to the data filter and configured to capture the plurality of vehicle data.

13. The system for vehicle data integration according to claim 12, wherein each of the plurality of hardware systems further comprises:
a RFID reader, configured to capture at least one E-tag signal of all vehicles passing through one of the plurality of surveillance stations; and
an ANPR camera, configured to capture at least one vehicle image of all vehicles passing through the surveillance station.

14. The system for vehicle data integration according to claim 11, wherein the plurality of vehicle data comprises:
at least one E-tag signal; and
at least one vehicle image.

15. The system for vehicle data integration according to claim 14, wherein the least one E-tag signal comprises at least one E-tag data, and the least one vehicle image comprises at least one license plate data.
